(19) United States
(12) Patent Application Publication
(10) Pub. No.: US 2008/0043984 A1
(43) Pub. Date: Feb. 21, 2008

(54) Integrating disparate systems within a pre-set CTI framework for routing

(75) Inventors: Shailesh Gandhi, Boca Raton, FL (US); Peeyush Jaiswal, Boca Raton, FL (US); Naveen Narayan, Flower Mound, TX (US)

Correspondence Address: DUKE W. YEE, YEE AND ASSOCIATES, P.C., P.O. BOX 802333, DALLAS, TX, 75380, US

(73) Assignee: International Business Machines Corporation, Armonk, NY (US)

(21) Appl. No.: 11/494,344

(22) Filed: Jul. 27, 2006

(51) Int. Cl. H04M 3/00; H04M 5/00

(52) U.S. Cl. 379/265.03

(57) ABSTRACT

A connector application for integrating disparate systems within a pre-set computer telephony integration framework for routing calls is provided. The connector application receives input regarding a status of an agent of a plurality of agents. The connector application stores the status of each agent of the plurality of agents. The connector application receives a request for the status of each agent of the plurality of agents. The connector application then transmits the status of each agent of the plurality of agents to the requesting application.

### BACKGROUND OF THE INVENTION

1. Field of the Invention

The present invention relates generally to a data processing system. More specifically, the present invention relates to a computer implemented method, apparatus, and computer program product for integrating disparate systems within a pre-set computer telephony integration framework for routing calls.

2. Description of the Related Art

Contact centers with more than one disparate set of front end technologies face severe challenges regarding routing transactions that are in one technology based upon an agent state from another technology. As an example, a contact center dealing with Emergency roadside service (ERS) assistance in addition to general calls may wish to blend agents from disparate technologies, given that the ERS agents use both standard data processing system terminals and citizen band (CB) radio sets to communicate with contacts, and so forth. Inbound call routing for the ERS center using any standard out-of-the-box computer telephony integration (CTI) technology would not take into account the pre-existing disparate media, such as the CB radio in the present example. Computer telephony integration is the technology that links the computer, telephone and other services such as voice messaging and fax. Computer telephony integration improves the handling of the customer relationship. For example, customer details can be on screen while an agent answers the call. It is not possible for the out-of-the-box computer telephony integration technology to query the status of agents in the other media environment, the CB radio environment, for routing calls using the standard out-of-the-box computer telephony integration technology.

Currently, no automated methods exist for media bridging technology that provides automated bridging of calls between customer service representative (CSR) agents handling two or more different technologies. In such a case calls are generally manually transferred to the disparate agents to achieve this. Currently there is no means of automatically identifying blended CSR states.

### SUMMARY OF THE INVENTION

Exemplary embodiments describe a computer implemented method, a computer program product and a data processing system for integrating disparate systems within a pre-set computer telephony integration framework for routing calls. Input regarding a status of each agent of a plurality of agents is received. The status indicates whether the agent is engaged in activity utilizing a system that is disparate from the computer telephony integration framework for routing calls. The status of each agent of the plurality of agents is stored. A request for the status of each agent of the plurality of agents is received. The status of each agent of the plurality of agents is transmitted to a requesting application.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which exemplary aspects may be implemented;

FIG. 2 is a block diagram of a data processing system in which exemplary aspects may be implemented;

FIG. 3 is a block diagram of a system for integrating disparate systems within a pre-set computer telephony integration (CTI) framework for routing calls in accordance with an exemplary embodiment;

FIG. 4 is a block diagram of a connector application in accordance with an exemplary embodiment;

FIG. 5 is a flowchart illustrating the operation of integrating disparate systems within a pre-set computer telephony integration framework for routing calls in accordance with an exemplary embodiment; and

FIG. 6 is flowchart illustrating the operation of a connector application in accordance with an exemplary embodiment.

### DETAILED DESCRIPTION OF THE PREFERRED EMBODIMENT

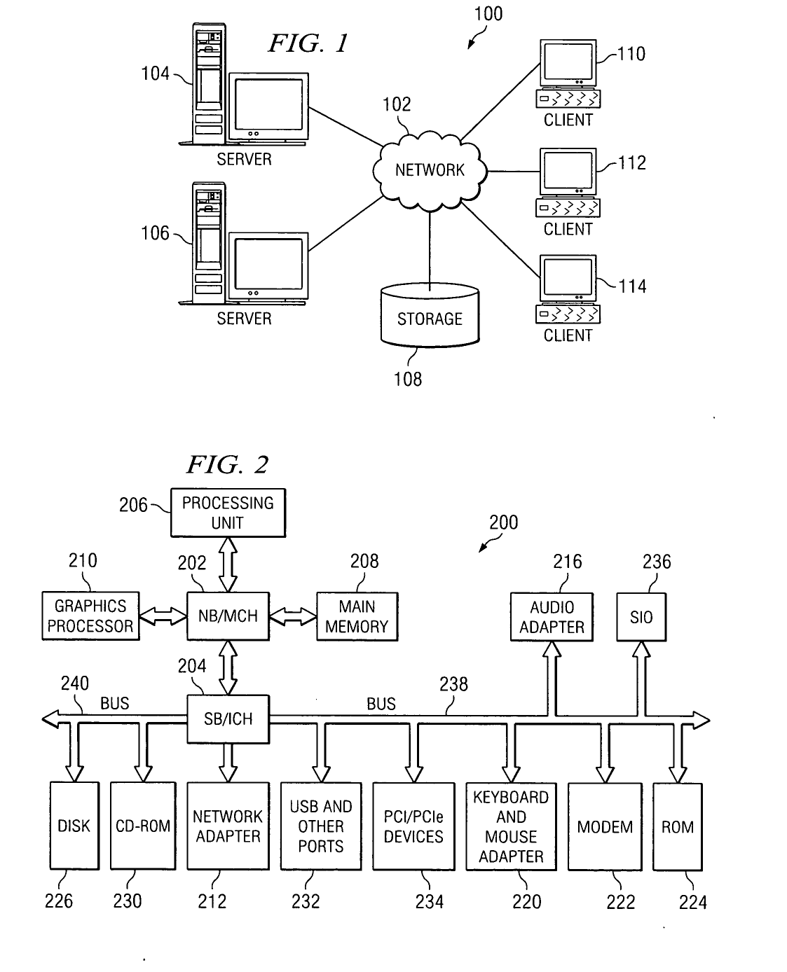

FIGS. 1-2 are provided as exemplary diagrams of data processing environments in which embodiments may be implemented. It should be appreciated that FIGS. 1-2 are only exemplary and are not intended to assert or imply any limitation with regard to the environments in which aspects or embodiments may be implemented. Many modifications to the depicted environments may be made without departing from the spirit and scope.

With reference now to the figures, FIG. 1 depicts a pictorial representation of a network of data processing systems in which aspects may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which aspects may be implemented. Data processing system 200 is an example of a computer, such as server 104 or client 110 in FIG. 1, in which computer usable code or instructions implementing the processes for embodiments may be located.

In the depicted example, data processing system 200 employs a hub architecture including north bridge and memory controller hub (NB/MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Exemplary embodiments solve the problem of integrating disparate systems within a pre-set computer telephony integration framework for routing calls by implementing a middle tier connector application coupled with a set of graphical user interfaces. A pre-set computer telephony integration framework for routing calls is an out of the box, already existing, computer telephony integration framework. Clients developed using the graphical user interfaces need to be installed on the data processing system used by the agent that is associated with the disparate media. For example, in the previously detailed example of the ESR agents using CB radio, the graphical user interface needs to be installed on the data processing system that agent uses that is associated with the CB radio communication of the agent.

The connector or bridging application is notified each time the state of the agent changes in the disparate application. In one embodiment the agent manually changes his/her status using the graphical user interface installed on the data processing system. However, depending upon the implementation and the disparate application being used, the data processing system may automatically update the status of the agent using the graphical user interface instead of the agent doing it manually. Therefore, any out-of-the-box routing engine can then query the connector application to determine the state of all the agents in the other disparate application and then route the inbound call according to the received information.

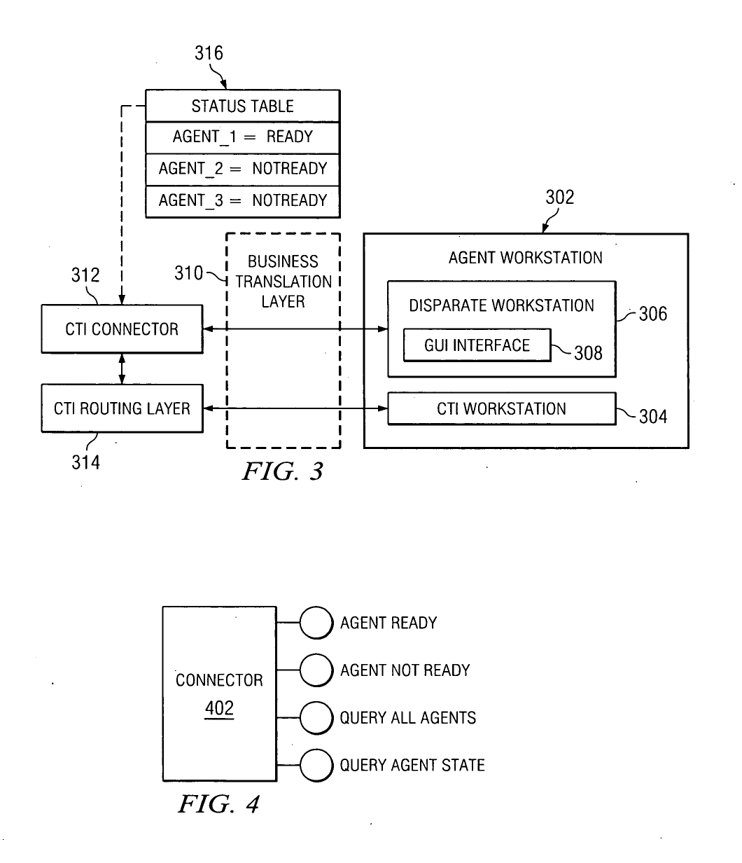

FIG. 3 is a block diagram of a system for integrating disparate systems within a pre-set computer telephony integration framework for routing calls in accordance with an exemplary embodiment. CTI framework 320 represents a pre-set, or out-of-the-box, computer telephony integration framework for routing calls. Agent workstation 302 is comprised of CTI workstation 304 and disparate workstation 306. While FIG. 3 only depicts a single agent workstation comprised of one CTI workstation and one disparate workstation, it should be understood that the system would be comprised of a plurality of agent workstations corresponding to plurality of agents. CTI workstation 304 and disparate workstation 306 may be implemented as a data processing system, such as data processing system 200 in FIG. 2. Disparate workstation 306 contains GUI interface 308. Disparate workstation 306 is associated with disparate, non-computer telephony integration media used by the agent. Examples of non-computer telephony integration media, or systems, are any outbound dialing applications and CB radio. GUI interface 308 is used by the agent to indicate the status of the agent. The status in these examples is either ready if the agent is not handling a call or not ready if the agent is handling a call. In an exemplary embodiment, selecting either a ready or not ready status by the agent at disparate workstation 306 causes GUI interface 308 to automatically notify CTI connector 312 of the status of the agent. In another embodiment, selecting either a ready or not ready status by the agent at disparate workstation 306 does not cause GUI interface 308 to notify CTI connector 312 of the status of the agent, rather CTI connector 312 must actively query disparate workstation 306 to obtain the status of the agent contained in GUI interface 308.

CTI connector layer 312 communicates with disparate workstation 306 and GUI interface 308 through business transaction layer 310. CTI routing layer 314 communicates with CTI workstation 304 through business transaction layer 310. CTI routing layer 314 may be any out-of-the-box call routing engine. When CTI routing layer 314 receives a call, CTI routing layer 314 queries CTI connector 312 to determine the status of the agents on the disparate workstations. Status table 316 shows an example of the status for various agents for several disparate workstations. CTI routing layer 314 also queries the CTI workstations to determine the availability of those workstations. CTI routing layer 314 selects an agent to receive the inbound call. CTI routing layer 314 then routes the inbound call to the CTI workstation of the selected agent.

The criteria for determining which agent to select to route the inbound call to varies with the specific implementation. For example, in one exemplary implementation, CTI call routing layer 314 would route an inbound call to the CTI workstation of an agent if either the CTI work station of the agent reports as available or if the disparate workstation reports a status of ready for the agent. In another exemplary implementation, CTI call routing layer 314 would route an inbound call to the CTI workstation of an agent only if both the CTI work station of the agent reports as available and the disparate workstation reports a status of ready for the agent.

FIG. 4 is a block diagram of a connector application in accordance with an exemplary embodiment. Connector 402 is an example of CTI connector 312 in FIG. 3. Connector 402 shows the various GUI layer interfaces supported by connector 402. An agent can indicate that an agent is either ready or not ready. A querying user or application can query all agents to see what agents are currently logged in. Alternatively, a user or application can query the connector to determine the state of all the agents.

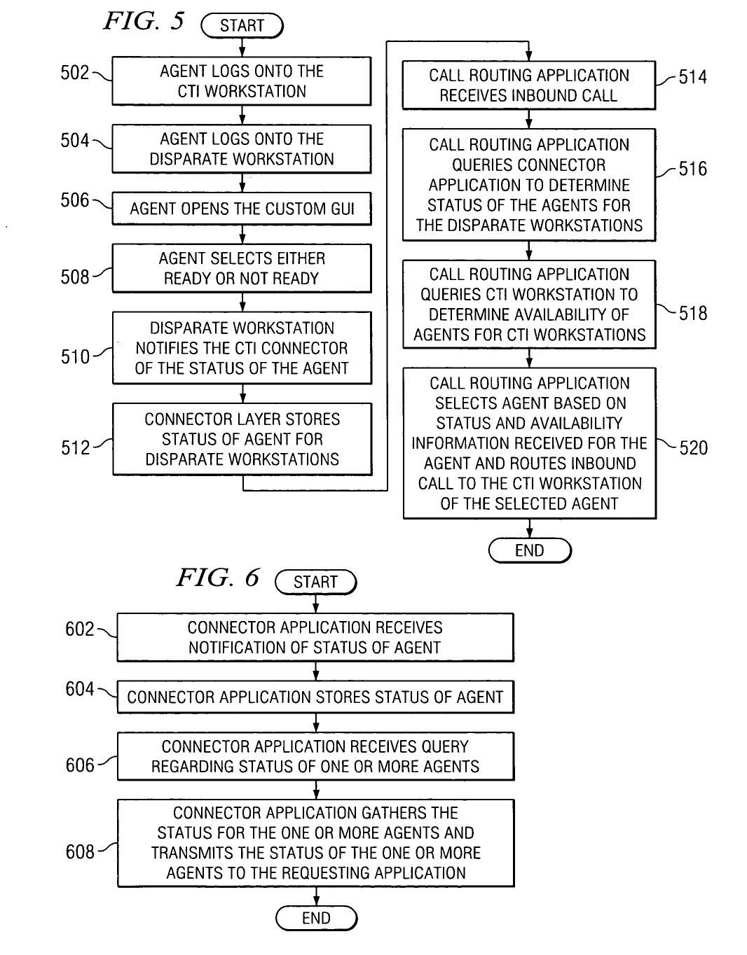

FIG. 5 is a flowchart illustrating the operation of integrating disparate systems within a pre-set computer telephony integration framework for routing calls in accordance with an exemplary embodiment. The operation of FIG. 5 may be implemented by the system depicted in FIG. 3, specifically by workstation 302, CTI routing layer 314 and CTI connector 312 in FIG. 3. The operation begins when an agent logs onto a CTI workstation, such as CTI workstation 304 in FIG. 3 (step 502). Then the agent logs onto a disparate workstation, such as disparate workstation 306 in FIG. 3 (step 504). The agent opens the graphical user interface on the disparate workstation (step 506). The graphical user interface may be implemented as GUI interface 308 in FIG. 3. It should be noted that while the flow chart depicts the agent as logging onto the CTI workstation first and then logging onto the disparate workstation, the order of logging on is not consequential. Also, while the present flowchart only indicates logging onto one disparate workstation per agent, an agent could be logged into multiple disparate workstations, each workstation being associated with a different media or application.

Opening the graphical user interface presents two buttons or check boxes or other selecting means for indicating whether the agent is in a ready state or a not ready state. The agent then selects either the ready or not ready state (step 508). The disparate workstation then notifies the connector application of the status of the agent (step 510). The notification sent to the connector application may contain additional business information beyond the agent state information such as the station identification, agent identity, and so forth. The connector layer stores the status of the agent for the disparate workstation (step 512). Next a call routing application receives an inbound call (step 514). The call routing application queries the connector application to determine the status of the agents for the disparate workstations (step 516). The call routing application also queries the CTI workstations to determine the availability of the agents for the CTI workstations (step 518). The call routing application then selects an agent based on the status and availability information received for the agent and routes the inbound call to the CTI workstation of the selected agent (step 520) and the operation ends.

FIG. 6 is flowchart illustrating the operation of a connector application in accordance with an exemplary embodiment. The operation of FIG. 6 may be implemented by a connector, such as CTI connector 312 in FIG. 3 or connector 402 in FIG. 4. The operation begins when the connector application receives notification of the status of an agent for a disparate workstation (step 602). The connector application stores the received status of the agent (step 604). The connector application receives a query regarding the status of one or more agents (step 606). The connector application gathers the stored status for the one or more agents and transmits the status of the one or more agents to the requesting application (step 608) and the operation ends.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for integrating disparate systems within a pre-set computer telephony integration framework for routing calls, the computer implemented method comprising:
receiving input regarding a status for each agent of a plurality of agents, wherein the status indicates whether an agent is engaged in activity utilizing a system that is disparate from the pre-set computer telephony integration framework for routing calls;
storing the status of each agent of the plurality of agents;
receiving a request from a requesting application for the status of each agent of the plurality of agents; and
transmitting the status for each agent of the plurality of agents to the requesting application.

2. The computer implemented method of claim 1, wherein the input is received from a remote data processing system.

3. The computer implemented method of claim 2, wherein the remote data processing system comprises a graphical user interface and wherein the graphical user interface comprises a status indicator that is selectable by the agent.

4. The computer implemented method of claim 1, further comprising:
receiving a request from a requesting application for the status of a particular agent of the plurality of agents; and
transmitting the status of the particular agent to the requesting application.

5. The computer implemented method of claim 1, further comprising:
querying a computer telephony integration workstation for each agent of the plurality of agents to determine an availability for each agent of the plurality of agents;
selecting an agent to receive the inbound call; and
routing the inbound call to the computer telephony integration workstation of the selected agent.

6. The computer implemented method of claim 5, wherein selecting the agent to receive the inbound call further comprises:
selecting the agent responsive to a determination that both the status of the agent is a ready status and that the computer telephony integration workstation of the agent is available.

7. The computer implemented method of claim 1, wherein the system comprises one of at least an outbound dialing application or a citizen band radio.

8. A computer program product comprising a computer usable medium including computer usable program code for integrating disparate systems within a pre-set computer telephony integration framework for routing calls, the computer-program product comprising:
computer usable program code for receiving input regarding a status of each agent of a plurality of agents, wherein the status indicates whether the agent is engaged in activity utilizing a system that is disparate from the computer telephony integration framework for routing calls;
computer usable program code for storing the status of each agent of the plurality of agents;
computer usable program code for receiving a request from a requesting application for the status of each agent of the plurality of agents; and
computer usable program code for transmitting the status of each agent of the plurality of agents to the requesting application.

9. The computer program product of claim 8, wherein the input is received from a remote data processing system.

10. The computer program product of claim 9, wherein the remote data processing system comprises a graphical user interface and wherein the graphical user interface comprises a status indicator that is selectable by the agent.

11. The computer program product of claim 8, further comprising:
computer usable program code for receiving a request from a requesting application for the status of a particular agent of the plurality of agents; and
computer usable program code for transmitting the status of the particular agent to the requesting application.

12. The computer program product of claim 8, further comprising:
computer usable program code for querying a computer telephony integration workstation for each agent of the plurality of agents to determine an availability for each agent of the plurality of agents;
computer usable program code for selecting an agent to receive the inbound call; and
computer usable program code for routing the inbound call to the computer telephony integration workstation of the selected agent.

13. The computer program product of claim 12, wherein the computer usable program code for selecting the agent to receive the inbound call further comprises:
computer usable program code for selecting the agent responsive to a determination that both the status of the agent is a ready status and that the computer telephony integration workstation of the agent is available.

14. The computer program product of claim 8, wherein the system comprises one of at least an outbound dialing application or a citizen band radio.

15. A data processing system for integrating disparate systems within a pre-set computer telephony integration framework for routing calls, the data processing system comprising:
a storage device, wherein the storage device stores computer usable program code; and
a processor, wherein the processor executes the computer usable program code to receive input regarding a status of each agent of a plurality of agents, wherein the status indicates whether the agent is engaged in activity utilizing a system that is disparate from the computer telephony integration framework for routing calls; store the status of each agent of the plurality of agents; receive a request from a requesting application for the status of each agent of the plurality of agents; and transmit the status of each agent of the plurality of agents to the requesting application.

16. The data processing system of claim 15, wherein the input is received from a remote data processing system.

17. The data processing system of claim 16, wherein the remote data processing system comprises a graphical user interface and wherein the graphical user interface comprises a status indicator that is selectable by the agent.

18. The data processing system of claim 15, wherein the processor further executes the computer usable program code to receive a request from a requesting application for the status of a particular agent of the plurality of agents; and transmit the status of the particular agent to the requesting application.

19. The data processing system of claim 15, wherein the processor further executes the computer usable program code to query a computer telephony integration workstation for each agent of the plurality of agents to determine an availability for each agent of the plurality of agents; select an agent to receive the inbound call; and route the inbound call to the computer telephony integration workstation of the selected agent.

20. The data processing system of claim 19, wherein the computer usable program code for selecting the agent to receive the inbound call further comprises:
computer usable program code for selecting the agent responsive to a determination that both the status of the agent is a ready status and that the computer telephony integration workstation of the agent is available.
